(19) United States
(12) Patent Application Publication
(10) Pub. No.: US 2006/0005838 A1
(43) Pub. Date: Jan. 12, 2006

(54) Multi-layer face mask with foamed in place edge member

(76) Inventor: Mark Magidson, Los Angeles, CA (US)

Correspondence Address: Charles M. Schwartz;Moldex-Metric, Inc., 10111 W. Jefferson Blvd., Culver City, CA, 90232, US

(21) Appl. No.: 10/888,471

(22) Filed: Jul. 7, 2004

(51) Int. Cl. A62B 18/02; A62B 23/02

(52) U.S. Cl. 128/206.19; 128/205.25

(57) ABSTRACT

A facemask to be worn upon the face of a wearer and for providing filtering of particular impurities in the air, including at least one layer of flexible material to conform to the contours of the face of the wearer and forming a flexible support carrier for filter material and with the one layer of flexible material allowing the passage of air through the one layer, a separate layer of filter material supported by the one layer of flexible material and with the filter material filtering out the particular impurities in the air, a foamed in place deformable edge member extending around the peripheral edge of the layers forming the facemask and with the foamed in place deformable edge member providing an edge seal between the facemask and the face of the wearer, and the foamed in place member including additional deformable portions extending inwardly to the interior of the mask from the foamed in place edge member at least in the areas of the sides of the nose and upper cheekbones of the wearer for providing additional sealing in those areas.

### BACKGROUND OF THE INVENTION

1. Field of the Invention

The present invention relates to face masks, and, in particular, facemasks formed from a plurality of layers and with the individual layers serving different functions and with a foamed edge member extending around the edge of the facemask.

2. Description of the Prior Art

In the prior art, facemasks have been constructed using a pair of flexible layers of fiberfill material and with a layer of filter material supported between the layers of fiberfill material. In the prior art facemasks, an edge portion of the facemask is heat sealed to form a line seal extending around the periphery of the mask and with this periphery line seal stiffening and sealing the edge portion of the facemask. In order to provide for the facemask of the prior art being sealed against the face of the wearer, a pair of elastic bands is attached to the facemask. The elastic bands extend around the head of the wearer so that the mask is pulled tightly against the face. The prior art facemasks also use a separate piece of foam rubber that is attached to the inner surface of the facemask and extend across the nose bridge portion of the mask. The piece of foam rubber provides for additional sealing of the mask in the nose bridge area. In addition, the prior art facemasks include a metal clip on the outside of the mask across the nose bridge portion, so that the wearer of the mask can bend the metal clip to maintain the foam rubber in sealing contact.

The prior art also includes the use of a molded rubber like edge bead as shown in Huber et al U.S. Pat. No. 4,454,881 which is assigned to the same assignee as the present application. This patent requires the use of high-pressure injection molding in a mold chamber formed by mold members to produce the molded rubber like edge bead. Such high-pressure injection molding is difficult to accomplish cleanly since the high-pressure will produce excess rubber like material extending onto the mask body in areas not perfectly sealed off by the mold members.

Generally, the masks of the prior art are uncomfortable to wear, since the mask is maintained very tightly against the face by the double bands and with the metal clip also squeezing the mask against the face in the nose bridge area. It will be appreciated that if the mask is uncomfortable to wear, there are times when workers will not wear the mask even though the use of a filter mask is indicated because of environmental conditions or fail to squeeze the metal noseband adequately.

The prior art masks with the molded rubber like edge bead are expensive to manufacture, and can produce uneven results, and can be uncomfortable for some wearers since, some wearers react to the rubber like material or find the rubber like material sticky, rigid and annoying.

### SUMMARY OF THE INVENTION

The present invention is directed to a multi-layer facemask that is comfortable to wear and which seals to the face of the wearer without the necessity of tight elastic bands or metal clip members or rubber like material. Reference is made U.S. Pat. No. 4,454,881 listing Otto L. Huber and Mark Magidson as inventors, which Patent is assigned to the assignee of the present application that shows a multi-layer facemask wherein at least one layer is formed out of an open-work, flexible plastic material so as to serve as a support layer for carrying at least another layer of filter material. This Patent discloses the use of a peripheral molded rubber like edge bead and with this rubber like edge bead, providing for a sealing of the mask against the face of the wearer.

The present invention is directed to an improved multi-layer facemask using a foamed in place edge member foamed around at least a portion of the periphery of the mask to provide for sealing, by deformation of the foamed member, especially around the nose and upper cheek area of the facemask. Specifically, in the present invention, the foamed in place edge member may also include foamed flange portions extending inwardly at least in the nose and upper cheek area of the mask. The flange portions are deformable and flexible and lie against the sides of the nose and the cheekbones of the wearer. The flange portions extend inwardly to lie against the side of the nose and the cheekbones and since the flange portions are deformable and flexible, they adapt to the various facial contours even during facial movement such as during speech or change of facial expression. Additionally, the foam material may be hydrophilic to absorb moisture from the face of the wearer to thereby provide for an increase in the comfort level of the facemask.

As indicated above, the foamed in place deformable edge member, with the flange portions, may extend along the nose and upper cheek areas, but the flange portion may also extend around additional areas of the mask to provide for additional sealing around the periphery of the mask. In addition, since the foamed in place edge member is formed by a foaming technique, the present invention provides for foaming in place additional integral portions of the foamed edge member to extend further on the inside or outside of the mask to provide for additional functions. For example, portions of the foamed member may be foamed in place under low pressure to extend either on the inside or the outside surface around the nose area to provide for additional comfort and support in this area. The foamed member may be foamed in place to extend into the inside or outside surface of the mask along the sides of the mask so as to provide for side supports for strap members to hold the mask against the face. The foamed member may be foamed in place to extend on the inside or outside surface of the mask at a bottom portion to allow for the insertion of an exhalation valve.

With the facemask of the present invention, the pair of layers of non-woven material provide for a flexible shape-retaining carrier support for the filter material. The fiberfill layers allow for the generally unrestricted passage of air, which air is filtered by the intermediate filter layer. The layer of filter material may be of any of the general types of filter material commonly used in face masks for providing for the filtering of particular impurities in the air. Some of the filter materials currently used are not shape retaining or self-supporting, so it is necessary to use some sort of carrier means, such as the non-woven layers, to provide for the support of the filter material. It is to be appreciated, however, that in place of the non-woven layers an open-work layer of plastic material, such as shown in the previously referred to U.S. Pat. No. 4,454,881, may be used.

The filter material may be formed from various types of filter material such as electrostatically-charged woven or non-woven polyester or polypropylene fibers, fiberglass, activated charcoal impregnated sheets or particles, various types of natural fibers and other types of filter materials commonly used.

The foamed in place edge member may be formed from any compressible resilient foam polymer with either fast or slow recovery properties such as polyurethane or polyvinyl chloride. Typical chemical systems are made up of two liquid components. When the components are mixed together, this causes a chemical reaction that creates a soft foam material under low pressure that gradually becomes the solid foam edge member. The initial exposure to the mask occurs when the material is substantially in liquid form and the bond between the mask body and edge member can be very strong since, when in the liquid state, the material can intermingle with the fibers forming the mask body. A cure time under low pressure of approximately 10 minutes or less is preferable.

### BRIEF DESCRIPTION OF INVENTION

FIG. 1 is a front view of a first embodiment of a facemask constructed in accordance with the teachings of the present invention having a foamed in place deformable edge member extending around the periphery of the facemask.

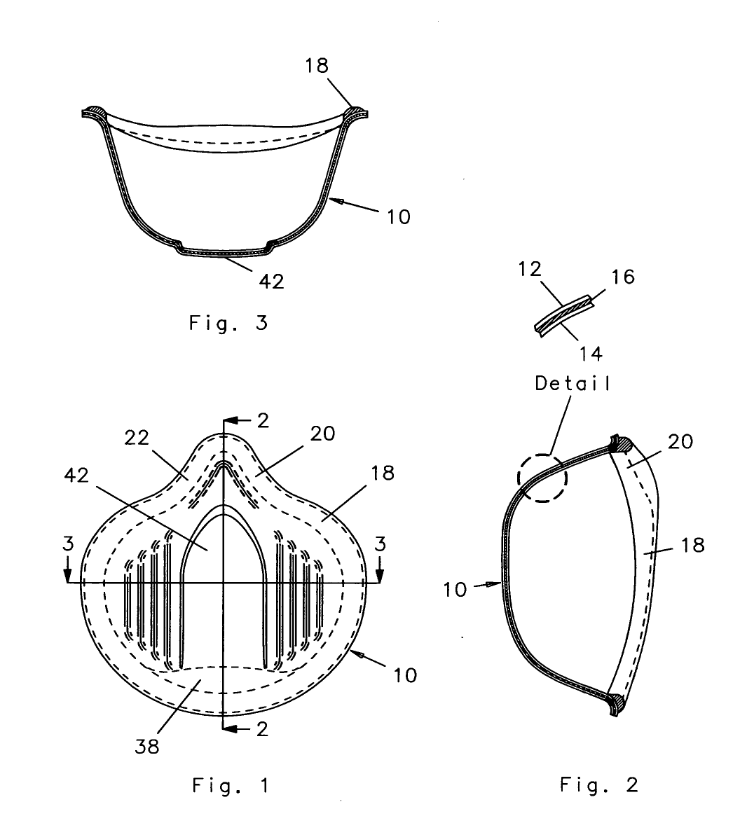

FIG. 2 is a cross sectional view of the facemask of FIG. 1 taken along lines 2-2 of FIG. 1 and includes a fragmentary view of the layers forming the mask body.

FIG. 3 is a cross sectional view of the facemask of FIG. 1 taken along lines 3-3 of FIG. 1.

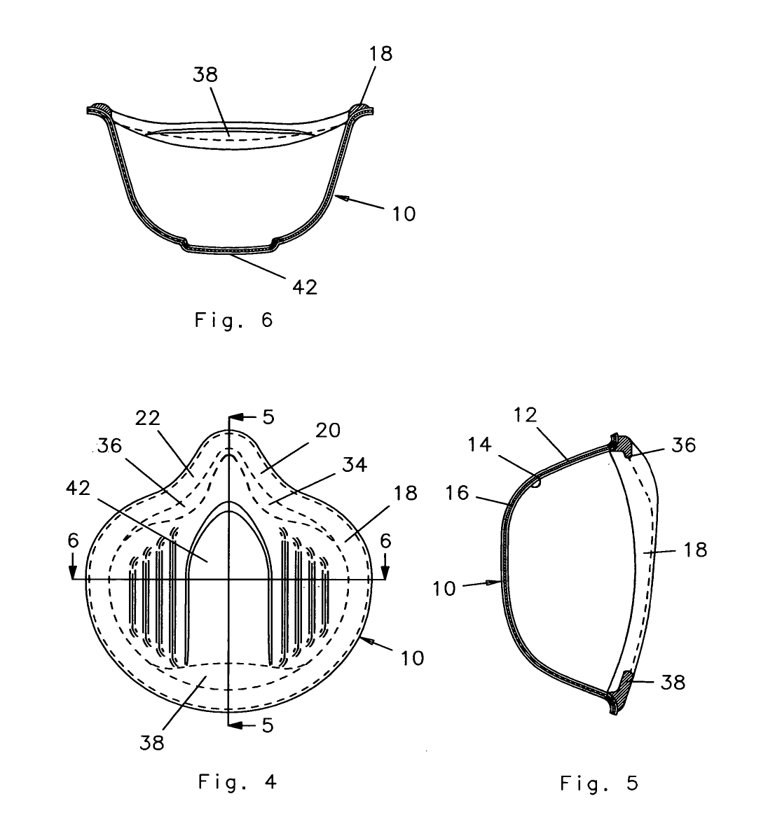

FIG. 4 is a front view of a second embodiment of a facemask constructed in accordance with the teachings of the present invention having a foamed in place deformable edge member extending around the periphery of the facemask and with flange portions at least in particular areas.

FIG. 5 is a cross sectional view of the facemask of FIG. 4 taken along lines 5-5 of FIG. 4.

FIG. 6 is a cross sectional view of the facemask of FIG. 4 taken along lines 6-6 of FIG. 4.

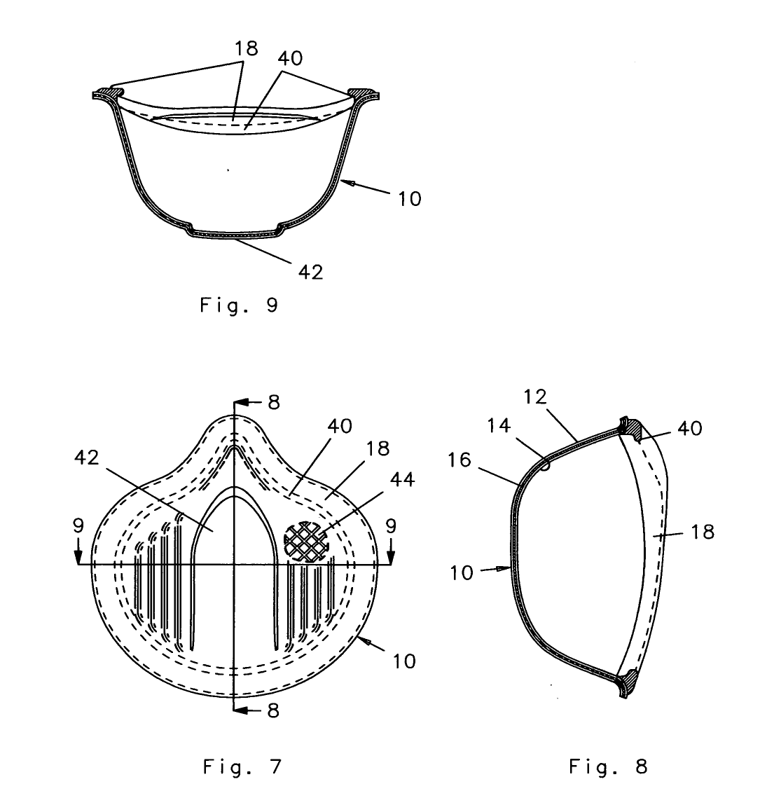

FIG. 7 is a front view of a third embodiment of a facemask constructed in accordance with the teachings of the present invention having a foamed in place deformable edge member with flange portion extending around the periphery of the facemask.

FIG. 8 is a cross sectional view of the facemask of FIG. 7 taken along lines 8-8 of FIG. 7.

FIG. 9 is a cross sectional view of the facemask of FIG. 7 taken along lines 9-9 of FIG. 7.

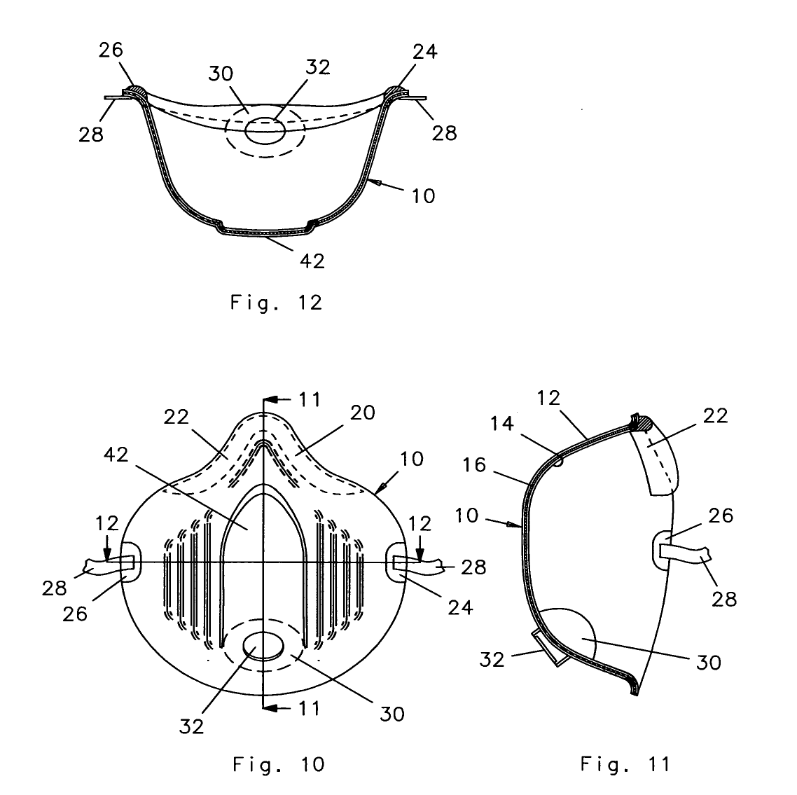

FIG. 10 is a front view of a fourth embodiment of a facemask constructed in accordance with the teachings of the present invention having a foamed in place deformable edge member extending in the nose area of the facemask.

FIG. 11 is a cross sectional view of the facemask of FIG. 10 taken along lines 11-11 of FIG. 10.

FIG. 12 is a cross sectional view of the facemask of FIG. 10 taken along lines 12-12 of FIG. 10.

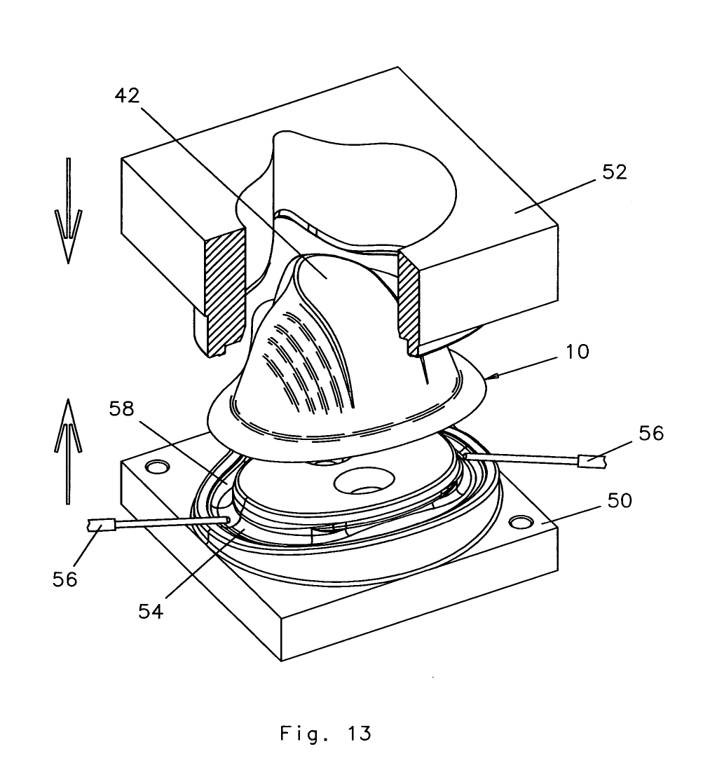

FIG. 13 illustrates an exploded view of a mold structure used in a method of producing the present invention for foaming in place the deformable edge member around the periphery of the mask.

FIGS. 1 through 3 illustrates a first embodiment of a facemask 10 of the present invention, which facemask is formed from three layers of material. Specifically, the facemask 10 includes an outer flexible layer 12 which may be formed as a fiberfill shell. The outer shell 12 may be molded using non-woven polyester fibers and the shell serves as an outer support layer and pre-filter. An inner flexible layer 14 may also be formed as a fiberfill shell and may also be molded using non-woven polyester fibers. The layers 12 and 14 may not have the exact characteristics, and, as an example, the outer layer 12 may be formed of larger fibers than the inner layer 14 so that the inner layer, by being formed of finer fibers, may have a softer and therefore more comfortable surface to lie against the face of the wearer.

The inner and outer layers 12 and 14 are used to sandwich a middle layer 16 of filter material. This filter material may be formed of any known type of filter material so as to provide for filtering of particular elements in the air. For example, the following type of filter material has been used to provide for filtering but it is to be appreciated that other filter material may be used; activated charcoal-treated sheets or sheets formed from charcoal particles, fiberglass material, electrostatic material such as made from fine denier non-woven polyethylene or polypropylene fibers or natural materials. The present invention contemplates using any of these known types of filtering material for the center layer 16 sandwiched and supported by the outer layers 12 and 14.

The present invention also incorporates a foamed in place deformable edge member 18 of deformable foam material extending around the peripheral edge of the facemask 10. Specifically, as shown in FIGS. 2 and 3 the three layers 12, 14 and 16 are sealed together around the periphery and an edge member 18 is located around the sealed periphery of the facemask since the edge member 18 is foamed in place around the peripheral portion of the layers. The foamed in place edge member may be formed from any compressible resilient foam polymer with either fast or slow recovery properties such as polyurethane or polyvinyl.

The foamed in place deformable edge member 18 is foamed to at least include areas 20 and 22 which areas extend inwardly in the nose bridge and cheekbone areas of the mask 10. FIGS. 10-12 illustrate a fourth embodiment of the invention wherein the foamed in place deformable edge member is located only in selected areas such as in the areas 20 and 22 so as to extend inwardly in the nose bridge and cheekbone areas of the mask 10. The embodiment of FIGS. 10-12 also include the use of the foamed in place deformable edge member in areas 24 and 26 to accept a strap 28 and in area 30 to support an exhalation valve 32. The exhalation valve 32 allows for a freer passage of air exhaled by the wearer of the mask.

FIGS. 4 through 6 illustrate a second embodiment of the invention similar to the first embodiment but additionally including foamed in place flange portions 34 and 36 formed at an angle relative to the three layers 12, 14 and 16 and the edge member 18. This may be clearly seen with reference to FIGS. 4 and 5. The flange portions 34 and 36 are relatively thin and deformable and relatively soft to thereby deform and bend easily. The flange portions 34 and 36 therefore provide for a deformable and flexible surface to conform to the facial contours of the wearer and thereby produce an additional sealing of the mask against the face of the wearer along the sides and nose bridge of the nose and the upper cheekbone portions. The foamed in place deformable edge member 18 itself provides for sealing of the mask against the face of the wearer and the flange portions 34 and 36 provide for additional sealing in the critical area around and along the sides of the nose and along the upper cheekbones to accommodate facial contours of varying characteristics. The additional flange portions 34 and 36 may also be incorporated into the fourth embodiment of FIGS. 10-12 so as to provide for additional sealing in the nose area of the face of a wearer of the facemask.

The embodiment of FIGS. 4 through 6 also includes a flange portion 38 in the chin area of the facemask 10 to provide for additional sealing in the critical area around and along the sides of the chin to accommodate facial contours of varying characteristics.

FIGS. 7 through 9 illustrates a third embodiment of the invention. In this third embodiment the foamed in place deformable edge member 18 includes a flexible and deformable flange portion 40 extending completely around the inner surface of the facemask. The flange portion 40 therefore provides for the additional flange sealing, not only in the nose bridge and chin areas but also extending completely around the periphery of the facemask.

All of the embodiments of the invention may include additional integral molded portions in the body of the facemask to provide for additional support in the nose bridge and cheek area. As shown in drawings the facemask includes an integral molded area 42, which extends over the nose bridge portion of the mask so as to provide for an additional resilient support for the nose bridge portion of the mask. In particular, the area 42 may be molded so that the nose bridge portion has a relatively narrow configuration that would become spread apart as the mask is placed on the face of the wearer. The area 42 therefore acts as a resilient, springy support surface to tend to maintain the nose bridge portion of the foamed in place deformable edge member 18 in contact with the face of the wearer. In addition, the area 42 may form flat pad portions on each side of the nose to receive and support nosepiece portions of eyeglasses to prevent the glasses from sliding forward.

It is to be appreciated that any of the embodiments of the facemask may have at least one of the inner or outer support layers is formed from open-work plastic as shown by open-work plastic 44 in the third embodiment of FIGS. 7 through 9. This open work plastic would be similar to that shown in U.S. Pat. No. 4,454,881 referred to earlier. It is also to be appreciated that the facemask may also be formed of soft material to have a flat configuration and with the facemask wrapped across the face of the wearer. A foamed in place edge member may be provided with such a mask to accomplish the purposes of the present invention.

FIG. 13 through 15 illustrates structure for providing for the foaming in place the edge member of any of the embodiments of the facemask 10 of the present invention. In particular, FIG. 13 illustrates the foaming in place of the edge member to the facemask 10 with an additional flange extending around the periphery of the edge member and with additional flange portions in the nose bridge and chin areas. This would be a combination of the second and third embodiment of the present invention.

As can be seen in FIG. 13 male and female mold members 50 and 52 include surfaces conforming to the desired shape of the face mask 10 and a void 54 that extends around the periphery of the mold members. The inner and outer support layers 12 and 14 and the filter material 16 may be precut to the desired configuration and then edge sealed in the mold members 50 and 52. Alternatively, the three layers 12, 14 and 16 may be preformed to the desired edge seal and then placed between the mold members 50 and 52. In either case, the edge portion of the layers forming the mask 10 is positioned within the opening between the mold members so as to receive the foamed in place deformable edge member 18.

The void 54 is filled with foamable material 58 using nozzles 56 and the mold members are closed so the foamable material foams in place at low pressure only in the void 54 and attaches by adhesion to the periphery of the face mask to form the various embodiments of the invention dependent upon the specific structure of the mold members 50 and 52. The foaming occurs under low pressure since the mold members are used only to contain the foamable material within the void 54 and the pressure is limited to the pressure produced by the foaming action of the foamable material.

As can be seen in FIG. 13, the opening between the mold members 50 and 52 have a configuration so as to form the foamed in place deformable edge member 18 and to also integrally form the flange portions 34 and 36 as shown in FIG. 4 and the flange portion 40 as shown in FIG. 7. The mask 10 formed by the mold members 50 and 52, therefore, includes the layers of support material and the intermediate filter layer and additionally include the foamed in place deformable edge member 18 extending around the periphery of the mask and with the additionally integrally molded flexible and deformable flange portions 34, 36 and 40.

Also, the mold members 50 and 52 and the void area 54 may have an internal configuration to provide for any of the additional low pressure foamed in place deformable surfaces and portions as shown by any of the embodiments of the invention.

The foamed in place edge member 18 and any additional foam portions may be formed from any compressible resilient foam polymer with either fast or slow recovery properties such as polyurethane or polyvinyl chloride. Typical chemical systems are made up of two liquid components. When the components are mixed together, they cause a chemical reaction that creates a soft foam material that gradually becomes the solid foam edge member. The initial exposure to the mask occurs when the material is in liquid form and the bond between the mask body and edge member can be very strong since, when in the liquid state, the material can intermingle with the fibers forming the mask body. A cure time of approximately 10 minutes or less is preferable.

It will be appreciated that in addition to the particular embodiments of the invention shown, other adaptations and modifications may be made and the invention is only to be limited by the appended claims.

1. A facemask to be worn upon the face of a wearer and for providing filtering of particular impurities in the air, including
at least one layer of flexible material to conform to the contours of the face of the wearer including the areas of the sides of the nose, the bridge of the nose and upper cheekbones and forming a flexible support carrier for filter material and with the at least one layer of flexible material allowing the passage of air through the one layer,
a separate layer of filter material supported by the at least one layer of flexible material and with the filter material filtering out the particular impurities in the air, and
a foamed in place deformable edge member extending at least partially around the peripheral edges of the at least one layer of flexible material and the separate layer of filter material forming the facemask and with the foamed in place deformable member providing an edge seal between the facemask and the face of the wearer.

2. The facemask of claim 1 wherein the at least one layer of flexible material is molded to have a shape to conform to the contours of the face of the wearer.

3. The facemask of claim 1 wherein the foamed in place deformable edge member includes additional deformable portions extending inwardly to the interior of the mask from the edge member and with the additional deformable portions at least in the areas of the sides of the nose and upper cheekbones of the wearer for providing additional sealing in those areas.

4. The facemask of claim 1 additionally including another layer of flexible material forming another flexible support carrier for the filter material and with the layer of filter material sandwiched between the layers of flexible material.

5. The facemask of claim 1 wherein the foamed in place deformable edge member additionally includes an integrally flange portion extending from the edge member material at least in the nose bridge area of the facemask to form an additional sealing surface in the nose bridge area.

6. The facemask of claim 1 wherein that at least one layer of flexible material is composed of non-woven fibers formed as a non-woven shell.

7. The facemask of claim 1 wherein the at least one layer of flexible material is formed of openwork flexible plastic material.

8. The facemask of claim 1 wherein the foamed in place deformable edge member extends completely around the periphery of the facemask.

9. The facemask of claim 1 additionally including a strap member and wherein foamed in place deformable edge member includes integrally foamed portions for receiving and supporting the ends of the strap member.

10. The facemask of claim 9 wherein the integrally foamed portions for receiving and supporting the ends of the strap member extend over and are foamed to the at least one layer of flexible material along the sides of the facemask.

11. The facemask of claim 1 wherein the foamed in place deformable edge member additionally includes an integrally flange portion extending from the edge member material around the periphery of the facemask.

12. The facemask of claim 1 additionally including an exhalation port extending through the layers adjacent the peripheral edges thereof, the edge member including an integrally foamed portion extending over and foamed to the at least one layer of flexible material and over said exhalation port, said integrally foamed portion defining an integrally molded exhalation valve seat adapted to cooperate with an exhalation value member.

13. A method of producing a facemask to be worn upon the face of a wearer and for providing filtering of particular impurities in the air, including the following steps,
providing at least one layer of flexible material to conform to the contours of the face of the wearer including the areas of the sides of the nose, the bridge of the nose and upper cheekbones and forming a flexible support carrier for filter material and with the at least one layer of flexible material allowing the passage of air through the one layer,
providing a separate layer of filter material supported by the at least one layer of flexible material and with the filter material filtering out the particular impurities in the air, and
foaming in place a deformable edge member extending at least partially around the peripheral edges of the at least one layer of flexible material and the separate layer of filter material forming the facemask and with the foamed in place deformable member providing an edge seal between the facemask and the face of the wearer.

14. The method of claim 13 wherein the at least one layer of flexible material is molded to have a shape to conform to the contours of the face of the wearer.

15. The method of claim 13 wherein the deformable edge member is foamed in place to provide additional deformable portions extending inwardly to the interior of the mask from the edge member and with the additional deformable portions at least in the areas of the sides of the nose and upper cheekbones of the wearer for providing additional sealing in those areas.

16. The method of claim 13 additionally providing another layer of flexible material forming another flexible support carrier for the filter material and with the layer of filter material sandwiched between the layers of flexible material.

17. The method of claim 13 wherein the deformable edge member is foamed in place to additionally include an integrally flange portion extending from the edge member material at least in the nose bridge area of the facemask to form an additional sealing surface in the nose bridge area.

18. The method of claim 13 wherein the at least one layer of flexible material is composed of non-woven fibers formed as a non-woven shell.

19. The method of claim 13 wherein the at least one layer of flexible material is formed of openwork flexible plastic material.

20. The method of claim 13 wherein the foamed in place deformable edge member extends completely around the periphery of the facemask.

21. The method of claim 13 additionally providing a strap member and wherein the deformable edge member is foamed in place to include integrally foamed portions for receiving and supporting the ends of the strap member.

22. The method of claim 21 wherein the integrally foamed portions for receiving and supporting the ends of the strap member extend over and are foamed to the at least one layer of flexible material along the sides of the facemask.

23. The method of claim 13 wherein the deformable edge member is foamed in place to include an integrally flange portion extending from the edge member material around the periphery of the facemask.

24. The method of claim 13 additionally providing an exhalation port extending through the layers adjacent the peripheral edges thereof, the edge member including an integrally foamed portion extending over and foamed to the at least one layer of flexible material and over said exhalation port, said integrally foamed portion defining an integrally molded exhalation valve seat adapted to cooperate with an exhalation value member.

25. A facemask to be worn upon the face of a wearer and for providing filtering of particular impurities in the air, including
at least one layer of flexible material to conform to the contours of the face of the wearer including the areas of the sides of the nose, the bridge of the nose and upper cheekbones and forming a facemask and a flexible support carrier for filter material,
filter material supported by the at least one layer of flexible material and with the filter material filtering out the particular impurities in the air, and
a foamed in place deformable edge member extending at least partially around the peripheral edges of the at least one layer of flexible material forming the facemask and with the foamed in place deformable member providing an edge seal between the facemask and the face of the wearer.

26. The facemask of claim 25 wherein the at least one layer of flexible material is molded to have a shape to conform to the contours of the face of the wearer.

27. The facemask of claim 25 wherein the foamed in place deformable edge member includes additional deformable portions extending inwardly to the interior of the mask from the edge member and with the additional deformable portions at least in the areas of the sides of the nose and upper cheekbones of the wearer for providing additional sealing in those areas.

28. The facemask of claim 25 wherein the foamed in place deformable edge member additionally includes an integrally flange portion extending from the edge member material at least in the nose bridge area of the facemask to form an additional sealing surface in the nose bridge area.

29. The facemask of claim 25 wherein the foamed in place deformable edge member extends completely around the periphery of the facemask.

30. The facemask of claim 25 additionally including a strap member and wherein foamed in place deformable edge member includes integrally foamed portions for receiving and supporting the ends of the strap member.

31. The facemask of claim 30 wherein the integrally foamed portions for receiving and supporting the ends of the strap member extend over and are foamed to the at least one layer of flexible material along the sides of the facemask.

32. The facemask of claim 25 wherein the foamed in place deformable edge member additionally includes an integrally flange portion extending from the edge member material around the periphery of the facemask.

33. The facemask of claim 25 additionally including an exhalation port extending through the facemask adjacent the peripheral edges thereof, the edge member including an integrally foamed portion extending over and foamed to the at least one layer of flexible material and over said exhalation port, said integrally foamed portion defining an integrally molded exhalation valve seat adapted to cooperate with an exhalation value member.

34. A method of producing a facemask to be worn upon the face of a wearer and for providing filtering of particular impurities in the air, including the following steps,
providing at least one layer of flexible material to conform to the contours of the face of the wearer including the areas of the sides of the nose, the bridge of the nose and upper cheekbones and forming a facemask and a flexible support carrier for filter material,
providing filter material supported by the at least one layer of flexible material and with the filter material filtering out the particular impurities in the air, and
foaming in place a deformable edge member extending at least partially around the peripheral edges of the at least one layer of flexible material forming the facemask and with the foamed in place deformable member providing an edge seal between the facemask and the face of the wearer.

35. The method of claim 34 wherein the at least one layer of flexible material is molded to have a shape to conform to the contours of the face of the wearer.

36. The method of claim 34 wherein the deformable edge member is foamed in place to provide additional deformable portions extending inwardly to the interior of the mask from the edge member and with the additional deformable portions at least in the areas of the sides of the nose and upper cheekbones of the wearer for providing additional sealing in those areas.

37. The method of claim 34 wherein the deformable edge member is foamed in place to additionally include an integrally flange portion extending from the edge member material at least in the nose bridge area of the facemask to form an additional sealing surface in the nose bridge area.

38. The method of claim 34 wherein the foamed in place deformable edge member extends completely around the periphery of the facemask.

39. The method of claim 34 additionally providing a strap member and wherein the deformable edge member is foamed in place to include integrally foamed portions for receiving and supporting the ends of the strap member.

40. The method of claim 39 wherein the integrally foamed portions for receiving and supporting the ends of the strap member extend over and are foamed to the at least one layer of flexible material along the sides of the facemask.

41. The method of claim 34 wherein the deformable edge member is foamed in place to include an integrally flange portion extending from the edge member material around the periphery of the facemask.
